(19) United States
(12) Patent Application Publication
(10) Pub. No.: US 2017/0032371 A1
(43) Pub. Date: Feb. 2, 2017

(54) METHOD AND SYSTEM FOR NEXT GENERATION FLEET NETWORK

(71) Applicant: MasterCard International Incorporated, Purchase, NY (US)

(72) Inventors: Mark AQUILINA, Denver, CO (US); Aviva KLEIN, Toronto (CA); Alan BUCKLAND, East Grinstead (GB)

(73) Assignee: MasterCard International Incorporated, Purchase, NY (US)

(21) Appl. No.: 14/812,222

(22) Filed: Jul. 29, 2015

(51) Int. Cl. G06Q 20/40; G06Q 50/30; G06Q 20/34

(52) U.S. Cl. CPC G06Q 20/405; G06Q 20/34; G06Q 50/30

(57) ABSTRACT

A method for processing a fleet card transaction includes: storing, in a merchant file database, a plurality of merchant profiles, wherein each merchant profile includes at least a merchant identifier and at least one loop type identifier; receiving, by a receiving device and from a merchant device, an authorization request for a payment transaction, wherein the authorization request includes transaction data including at least a merchant identifier and a payment card identifier; identifying, by a processing device, the loop type identifier associated with the received transaction data; determining, by the processing device, whether to route the authorization request to one of a closed loop network and an open loop network based upon the loop type identifier associated with the received transaction data; and transmitting, by a transmitting device, the authorization request to a third party entity associated with either the closed loop network or the open loop network.

### FIELD

The present disclosure relates to the processing of fleet transactions, specifically a next generation network for processing fleet transactions for both open loop and closed loop issuers that simplifies the communications required by both fleet merchants and the issuers.

### BACKGROUND

The global fleet card market is a multi-billion dollar industry that supports transportation and logistics throughout the world. Traditionally, fleet cards have most often been issued by closed loop issuers, which are issuers that build relationships directly with merchants and through which their own issued fleet cards may be processed, with their own issued fleet cards unable to be processed by any other entity, and with the issuer being unable to process transactions for fleet cards issued by other issuers. Open loop issuers may, conversely, issue payment cards that can be processed by a payment network that processes payment transactions issued by a number of different issuers. While the closed loop system may be restrictive in such ways, it also offers a number of benefits that can sometimes outweigh the restrictions. For example, because the issuer is in a direct relationship with the merchant, the issuer can specify the type of data that is captured for a transaction, can build transaction rules that are individual to each merchant, can provide specialized services to each individual merchant on a per-merchant basis, etc.

However, fleet cards operating on closed loop networks can also suffer from a number of disadvantages. For example, because issuers are required to negotiate directly with each merchant, it can be both difficult and time consuming for an issuer to foster fleet card acceptance at a variety of merchants, which may result in a low amount of merchant acceptance. In addition, as each issuer may have specific rules and requirements, it may be difficult for a merchant to configure their system to operate pursuant to the requirements of a large number of issuers, resulting in an inability to accept a significant number of issuer fleet cards, which, in turn, may limit the merchant's customer base. In addition, communications occurring directly between each merchant and each fleet card issuer may require a vast and unique network infrastructure that many merchants and/or issuers may be unable to support.

Thus, there is a need for a technical solution that can provide a next generation fleet network for wider acceptance and use of fleet cards via an open loop network. More specifically, a traditional payment network may be able to facilitate transactions between fleet retail merchants and fleet card issuers, capturing the necessary level of data and ensuring compliance with issuer rules on behalf of the merchants and performing the requisite communications between parties, without requiring the merchants or issuers to reconfigure their existing systems or directly build new relationships. As a result, fleet card issuers may have access to additional merchants and merchants may have access to additional issuers via the payment network that may be difficult or impossible in traditional closed loop systems, resulting in a technical system where more merchants work together with more issuers, leading to increased revenue for all entities and providing greater utility to customers.

### SUMMARY

The present disclosure provides a description of systems and methods for processing fleet card transactions.

A method for processing a fleet card transaction includes: storing, in a merchant file database, a plurality of merchant profiles, wherein each merchant profile includes at least a merchant identifier and at least one loop type identifier; receiving, by a receiving device and from a merchant device, an authorization request for a payment transaction, wherein the authorization request includes transaction data including at least a merchant identifier and a payment card identifier; identifying, by a processing device, the loop type identifier associated with the received transaction data; determining, by the processing device, whether to route the authorization request to one of a closed loop network and an open loop network based upon the loop type identifier associated with the received transaction data; and transmitting, by a transmitting device, the authorization request to a third party entity associated with either the closed loop network or the open loop network.

A system for processing a fleet card transaction includes a merchant file database, a receiving device, a processing device, and a transmitting device. The merchant file database is configured to store a plurality of merchant profiles, wherein each merchant profile includes at least a merchant identifier and at least one loop type identifier. The receiving device is configured to receive, from a merchant device, an authorization request for a payment transaction, wherein the authorization request includes transaction data including at least a merchant identifier and a payment card identifier. The processing device is configured to: identify the loop type identifier associated with the received transaction data; and determine whether to route the authorization request to one of a closed loop network and an open loop network based upon the loop type identifier associated with the received merchant identifier. The transmitting device is configured to transmit the authorization request to a third party entity associated with either the closed loop network or the open loop network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for a next generation fleet card network in accordance with exemplary embodiments.

FIG. 2 is a block diagram illustrating the processing server of FIG. 1 for processing fleet card transactions using both open and closed loop networks in accordance with exemplary embodiments.

FIG. 3 is a flow diagram illustrating a process for processing fleet card transactions using open and closed loop networks using the system of FIG. 1 in accordance with exemplary embodiments.

FIG. 4 is a diagram illustrating network topologies for fleet card networks in accordance with exemplary embodiments.

FIG. 5 is a flow diagram illustrating a process for processing fleet card transactions using the processing server of FIG. 2 in accordance with exemplary embodiments.

FIG. 6 is a flow chart illustrating an exemplary method for processing a fleet card transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a customer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to customers as will be apparent to persons having skill in the relevant art, such as debit accounts, prepaid accounts, electronic wallet accounts, savings accounts, checking accounts, etc., and may provide customers with physical or non-physical means for accessing and/or utilizing such an account, such as debit cards, prepaid cards, automated teller machine cards, electronic wallets, checks, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Fleet Card—A type of payment card that is used for transportation related expenses. Issuers that issue fleet cards to an entity, such as a business or corporation, are often referred to as “fleet issuers.” In some instances, a fleet card may be usable as a traditional payment card at non-fleet merchants or at fleet merchants when used for non-transportation related expenses, such as the purchase of food at a fuel station separate from a transaction for the purchase of fuel. In many instances, payment transactions for which a fleet card is used may involve the transmission of additional data that is not traditionally included in a transaction message for a non-fleet payment transaction.

### Next Generation Fleet Network System

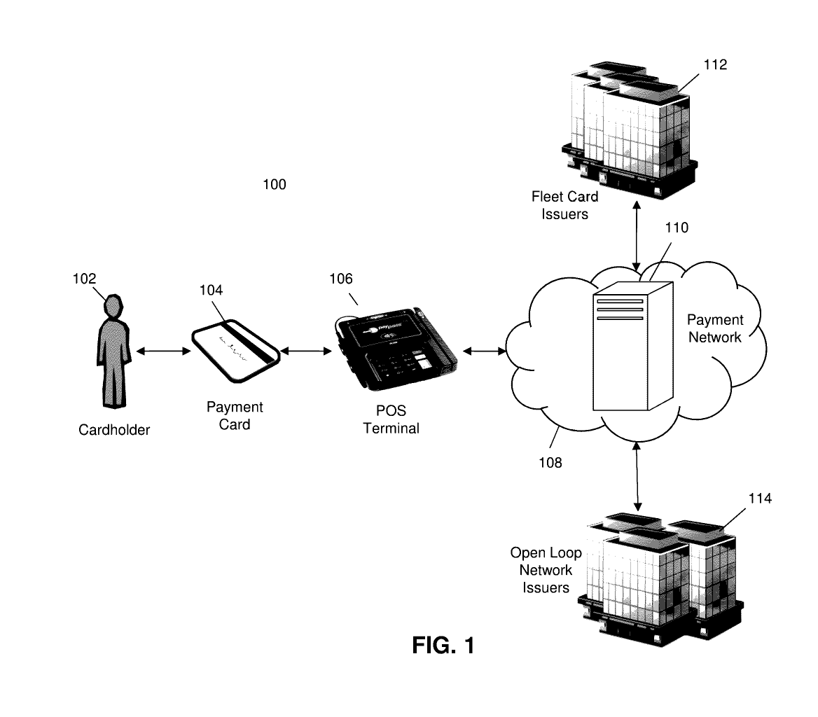

FIG. 1 illustrates a system 100 for a next generation fleet network that enables payment cards to be used as both fleet cards and traditional payment cards at fleet merchants and other merchants for both closed loop fleet card issuers and open loop network issuers.

In the system 100, a cardholder 102 may possess a payment card 104. The payment card 104 may be issued to the cardholder 102 by a financial institution, such as an issuing bank. In some instances, the payment card 104 may be a fleet card, a traditional non-fleet payment card, or a payment card configured for use in both fleet transactions and non-fleet transactions. In some embodiments, the financial institution may issue the payment card 104 to an employer of the cardholder 102. For example, the cardholder 102 may be an employee of a business that has a transaction account (e.g., a fleet account, a non-fleet account, or a combination thereof) with the financial institution. The financial institution may issue payment cards to the business, and the business may provide the payment card 104 to the cardholder 102 for use in payment transactions, which may include both fleet and non-fleet transactions.

The cardholder 102 may use the payment card 104 at a point of sale terminal 106 to fund a payment transaction. The point of sale terminal 106 may be located at a merchant, such as a fleet merchant or a non-fleet merchant. The point of sale terminal 106 may read payment details from the payment card 104 using methods and systems that will be apparent to persons having skill in the relevant art, such as via magnetic stripe, near field communication, a machine-readable code, EMV, chip and pin, etc. The point of sale terminal 106 may be configured to generate a transaction message for the payment transaction. The transaction message may be formatted pursuant to one or more standards associated with transaction messages and the interchange thereof, such as the International Organization for Standardization's ISO 8583 standard. For instance, the transaction message may include a plurality of data elements, each data element being configured to store data according to the associated standard(s).

For example, the point of sale terminal 106 may generate a transaction message that includes a message type indicator indicating that the transaction message is an authorization request for a payment transaction. The transaction message may include a plurality of data elements including a data element configured to store a primary account number that includes a payment card identifier, a data element configured to store merchant identification information that includes a merchant identifier, a data element configured to store a transaction amount, etc.

The point of sale terminal 106 may be configured to transmit the generated transaction message to a payment network 108 for processing. The payment network 108 may include a processing server 110. The processing server 110, discussed in more detail below, may be configured to process fleet card transactions in the system 100 using the methods and systems discussed herein. The processing server 110 may be configured to receive the transaction message from the point of sale terminal 106 using appropriate communication protocols for the sending and receipt of transaction messages and may be configured to identify data stored therein based on the one or more associated standards.

The processing server 110 may identify the payment card identifier stored in the data element configured to store a primary account number included in the received transaction message. The processing server 110 may identify a loop type identifier associated with the payment card 104 used in the transaction based on the payment card identifier, and may be configured to route the transaction message to a closed loop network or an open loop network based thereon. For example, the loop type identifier may correspond to a closed loop network operated by one of a plurality of fleet card issuers 112. In such an instance, the processing server 110 may route the transaction message to the associated fleet card issuer 112. In another example, the loop type identifier may correspond to an open loop network operated by one of a plurality of open loop network issuers 114. In such instances, the processing server 110 may route the transaction message to the associated open loop network issuer 114.

The appropriate issuer may receive the transaction message, which may be an authorization request, and may process it accordingly using traditional methods and systems that will be apparent to persons having skill in the relevant art. For instance, the issuer may determine if the associated transaction account has sufficient funds, may assess the transaction for fraud, etc. The issuer may then provide an authorization response to the processing server 110. The authorization response may be a separate transaction message or may be a modified version of the forward transaction message, such as where the message type indicator has been modified to indicate that the transaction message is an authorization response and a data element configured to store a response code modified to include a response code based on the processing performed by the issuer. For instance, the response code may indicate approval or denial of the transaction and/or a reason associated thereto (e.g., denied for lack of funds, etc.).

The processing server 110 may then forward the authorization response to the point of sale terminal 106. The point of sale terminal 106 and/or the associated merchant may then finalize the transaction accordingly. For example, if the authorization response indicates denial of the payment transaction, the merchant may inform the cardholder 102 and withhold goods or services. If the authorization response indicates approval of the payment transaction, the merchant may provide the transacted-for goods or services to the cardholder 102 and furnish the cardholder with a receipt.

In some embodiments, the point of sale terminal 106 may be configured to capture level 3 data for the payment transaction. Transaction data constituted as level 3 data will be apparent to persons having skill in the relevant art and may include data that is not included in a traditional payment transaction, such as product detail (e.g., product name, product identifier, unit amount, price per unit, etc.), cardholder data (e.g., an identification number, such as a driver's license number, etc.), etc. In fleet transactions, the level 3 data may include a vehicle identifier (e.g., a vehicle identification number), an odometer value, a purchase order number, a job identifier, etc. In some instances, the processing server 110 may indicate what data values may be required for the payment transaction. In such an instance, the data values may be based on rules set forth by the fleet card issuers 112 and/or open loop network issuers 114.

For example, a specific fleet card issuer 112 may require a purchase order number. In such an instance, the requirement may be provided to the processing server 110, which may be communicated to the point of sale terminal 106. The point of sale terminal 106 may then prompt for entry of a purchase order number for the transaction. In some instances, the point of sale terminal 106 may prompt for entry of specific data based on the payment card identifier read from the payment card 104, such as if the identifier or a portion thereof (e.g., a bank identification number) indicates a specific fleet card issuer 112, for which the point of sale terminal 106 is aware of required data. In some embodiments, the point of sale terminal 106 may capture all possible level 3 data and may transmit all of the data to the processing server 110 in the transaction message or in a transmission separate from the transaction message. In such embodiments, the processing server 110 may be configured to modify the transaction message prior to forwarding to the appropriate issuer to include the data requested by the issuer.

The methods and systems discussed herein may enable the processing server 110 and the payment network 108 to operate as a next generation fleet network for improved processing of fleet card transactions. As the processing server 110 performs the routing of transactions to the appropriate issuers, merchants may not be required to develop communication networks and infrastructure with a plurality of different fleet card issuers, as is performed in traditional systems. Instead, the merchant may provide transaction messages directly to the processing server 110, which may route the messages accordingly. In addition, this may further simplify merchant processing by routing both fleet card transactions and traditional payment card transactions.

In addition, in embodiments where the processing server 110 may be configured to apply rules to transaction data and/or transaction messages, and to modify transaction messages to include data based on issuer rules, merchant systems may be even further simplified. For instance, merchant point of sale terminals 106 may be configured to gather transaction data and generate authorization requests without being specially configured to perform additional functions based on each fleet card issuer 112, which may further facilitate card acceptance by merchants and simplify merchant processing to enable faster and more cost-affordable transactions. Accordingly, the methods and systems discussed herein provide for faster, more efficient processing of fleet card transactions, and can improve communications between merchants and fleet card issuers by providing for a communication infrastructure that is vastly improved over traditional systems.

### Processing Server

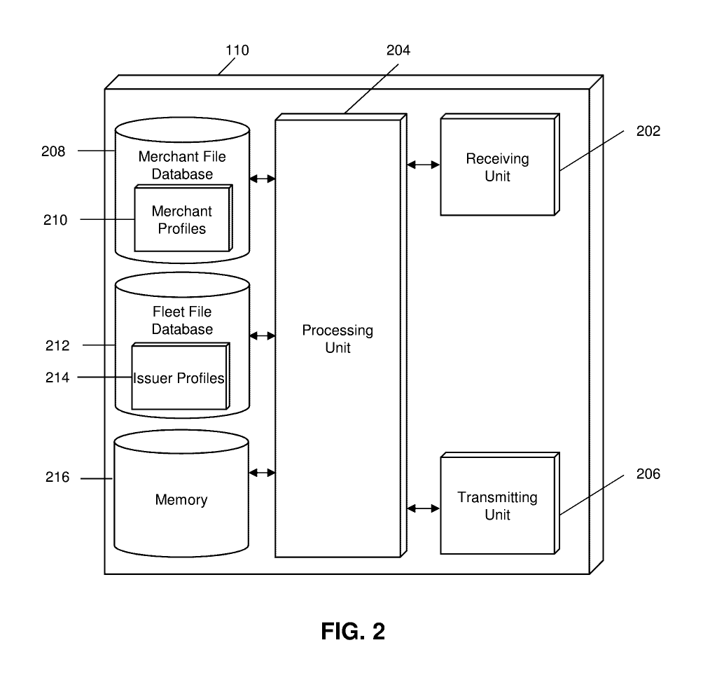

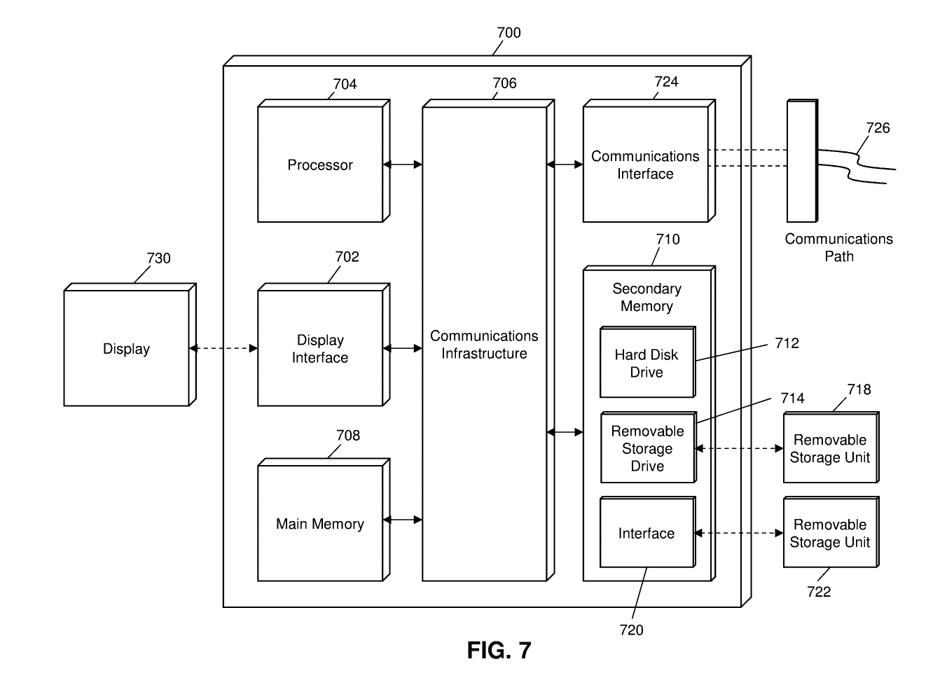

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 700 illustrated in FIG. 7 and discussed in more detail below may be a suitable configuration of the processing server 110.

The processing server 110 may include a merchant file database 208. The merchant file database 208 may be configured to store a plurality of merchant profiles 210. Each merchant profile 210 may be configured to store data related to a merchant (e.g., associated with one or more point of sale terminals 106) including at least a merchant identifier and at least one loop type identifier. The merchant identifier may be a value suitable for use in identification of the corresponding merchant profile 210 and/or the associated merchant or point of sale terminal 106, such as a merchant identification number. The loop type identifier may be a unique value associated with an issuer network configured to process payment card transactions. For example, the loop type identifier may be associated with a closed loop network, which may be operated by and/or associated with a fleet card issuer 112. In some instances, a merchant profile 210 may include a plurality of loop type identifiers, such as one associated with each issuer for whom the associated merchant accepts payment cards.

The processing server 110 may also include a fleet file database 212. The fleet file database 212 may include a plurality of issuer profiles 214. Each issuer profile 214 may be configured to store data related to a fleet card issuer 112 including at least an issuer identifier. The issuer identifier may be a unique value associated with the related fleet card issuer 112 used for the identification thereof, such as a bank identification number, network address, etc. In some embodiments, an issuer profile 214 may further include one or more transaction rules. The transaction rules may include rules for modification of a transaction message, rules regarding data to be included in a transaction message, required level 3 data values, etc. For example, an issuer profile 214 may include specific level 3 data values that are required for a transaction as well as formatting rules for inclusion of the level 3 data values in a transaction message.

The processing server 110 may further include a receiving unit 202. The receiving unit 202 may be configured to receive data over one or more networks via one or more network protocols for use in performing the functions disclosed herein. For instance, the receiving unit 202 may be configured to receive transaction messages via the payment network 108 using communication protocols associated with the interchange of transaction messages. Received transaction messages may be transmitted and/or formatted pursuant to one or more standards, such as the ISO 8583 standard, and may include authorization requests and authorization responses. The receiving unit 202 may also be configured to receive rules from fleet card issuers 112, such as rules for modification of transaction messages.

The processing server 110 may also include a processing unit 204. The processing unit 204 may be configured to perform the functions of the processing server 110 discussed herein as will be apparent to persons having skill in the relevant art. The processing unit 204 may be configured to update issuer profiles 214 based on rules received by the receiving unit 202 from associated fleet card issuers 112. The processing unit 204 may also be configured to identify data included in received authorization requests based on the associated standard(s) for processing of the corresponding payment transaction. The processing unit 204 may identify a merchant profile 210 stored in the merchant file database 208 based on a corresponding between the included merchant identifier and a merchant identifier stored in the appropriate data element in a received authorization request. The processing unit 204 may also identify an issuer profile 214 in the fleet file database 212 that includes an issuer identifier corresponding to a loop type identifier stored in the identified merchant profile 210.

The processing unit 204 may be further configured to modify a received authorization request. For example, the processing unit 204 may modify data included in one or more data elements and/or store additional data in one or more data elements based on rules included in the identified issuer profile 214. The processing unit 204 may also be configured to modify authorization responses, such as based on response codes, issuer rules, etc.

The processing server 110 may also include a transmitting unit 206. The transmitting unit 206 may be configured to transmit data over one or more networks via one or more network protocols to perform the functions of the processing server 110 discussed herein. For instance, the transmitting unit 206 may be configured to route transaction messages to fleet card issuers 112 and open loop network issuers 114. Transaction messages may be routed to issuers based on data included therein and/or identified by the processing unit 204. For instance, the processing unit 204 may identify a merchant profile 210 for the transaction and may instruct the transmitting unit 206 where to route the transaction message based on the loop type identifier stored in the identified merchant profile 210. The transmitting unit 206 may transmit transaction messages pursuant to associated standards and communication protocols associated thereof. The transmitting unit 206 may also be configured to transmit authorization responses to merchants (e.g., point of sale terminals 106) as responses to authorization requests received by the receiving unit 202.

The processing server 110 may also include a memory 216. The memory 216 may be configured to store data suitable for performing the functions of the processing server 110 as discussed herein. For example, the memory 216 may be configured to store rules and/or data associated with standards regarding the interchange of transaction messages, traditional payment transaction processing rules, fraud algorithms, risk algorithms, etc. Additional data that may be stored in the memory 216 will be apparent to persons having skill in the relevant art.

It will also be apparent to persons having skill in the relevant art that the processing server 110 may include additional components and/or that the components included in the processing server 110 as illustrated in FIG. 2 and discussed herein may be further configured to perform additional functions. For example, the processing server 110 may be further configured to perform the traditional functions of a payment network 108, for which the processing server 110 may include additional components and/or for which the components of the processing server 110 illustrated in FIG. 2 and discussed herein may be further configured.

### Processing Fleet Card Transactions in a Next Generation Fleet Network

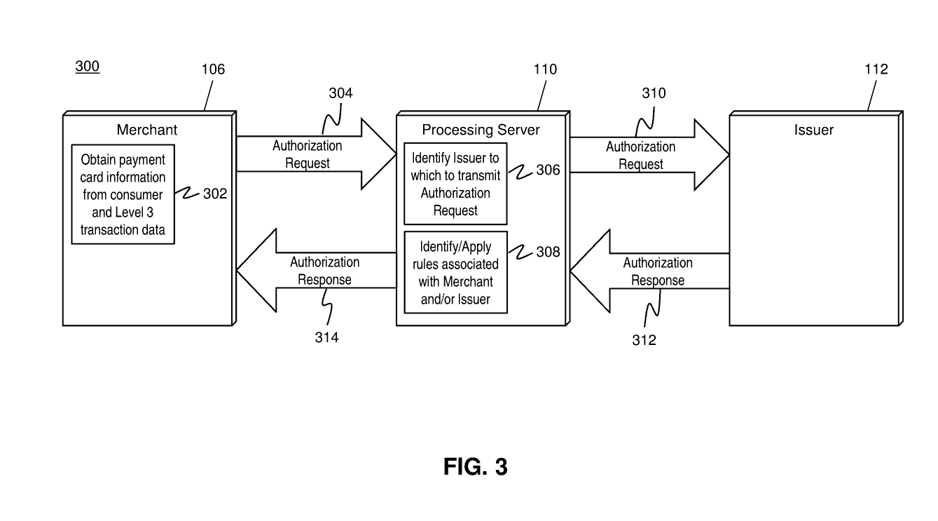

FIG. 3 illustrates a process 300 for the processing of fleet card transactions in a next generation fleet network using the system 100.

In step 302, a merchant 106 may obtain payment card information from a payment card 104 of a customer (e.g., the cardholder 102) and level 3 transaction data. The payment card information may be read from the payment card 104 using traditional methods and systems. The level 3 transaction data may be captured by the merchant 106 (e.g., via the point of sale terminal) using methods that will be apparent to persons having skill in the relevant art, such as manual data entry by an employee or the cardholder 102, the reading of machine-readable code encoded with data, data transmission over a network or near field communication, etc.

In step 304, the merchant 106 may transmit an authorization request to the processing server 110 via the payment network 108, to be received by the receiving unit 202. The authorization request may be a transaction message formatted pursuant to one or more standards, such as the ISO 8583 standard, that includes a message type indicator indicative of an authorization request. The authorization request may include a plurality of data elements including at least a first data element configured to store a primary account number that includes a payment card identifier (e.g., associated with the payment card 104 and read by the point of sale terminal 106), a second data element configured to store a merchant identifier (e.g., associated with the merchant and/or point of sale terminal 106), and one or more additional data elements configured to store the captured level 3 transaction data.

In step 306, the processing unit 204 of the processing server 110 may identify a fleet card issuer 112 to which to transmit the received authorization request. Identification of the fleet card issuer 112 may include identifying a merchant profile 210 stored in the merchant file database 208 that includes the merchant identifier included in the second data element included in the received authorization request, and then identifying a loop type identifier included therein. In some instances, the loop type identifier may correspond to data included in the authorization request, such as a portion of the payment card identifier (e.g., the bank identification number) stored in the first data element.

In step 308, the processing unit 204 of the processing server 110 may identify and apply any rules to the payment transaction associated with the merchant 106 and/or the fleet card issuer 112. The processing unit 204 may identify rules stored in the identified merchant profile 210 and/or included in an issuer profile 214 stored in the fleet file database 212 that includes an issuer identifier corresponding to the loop type identifier that was identified in step 306. The processing unit 204 may apply any identified rules, which may include modifying the authorization request, such as to modify data included in one or more data elements, include additional data in one or more data elements, remove data from one or more data elements, etc. For example, the processing unit 204 may format level 3 data based on one or more issuer rules and store the data in a specific element set forth in an additional issuer rule.

In step 310, the transmitting unit 206 of the processing server 110 may forward the authorization request (e.g., as modified) to the identified fleet card issuer 112. The fleet card issuer 112 may then process the payment transaction using traditional methods and systems and return, in step 312, an authorization response to the processing server 110. The authorization response may be received by the receiving unit 202 of the processing server 110 and include at least a data element configured to store a response code that indicates approval or denial of the payment transaction. In some instances, the authorization response may be a modification of the forwarded authorization request. In other instances, the authorization response may be a separate transaction message. In step 314, the transmitting unit 206 of the processing server 110 may forward the authorization response to the merchant 106, for finalization of the payment transaction.

### Next Generation Fleet Network

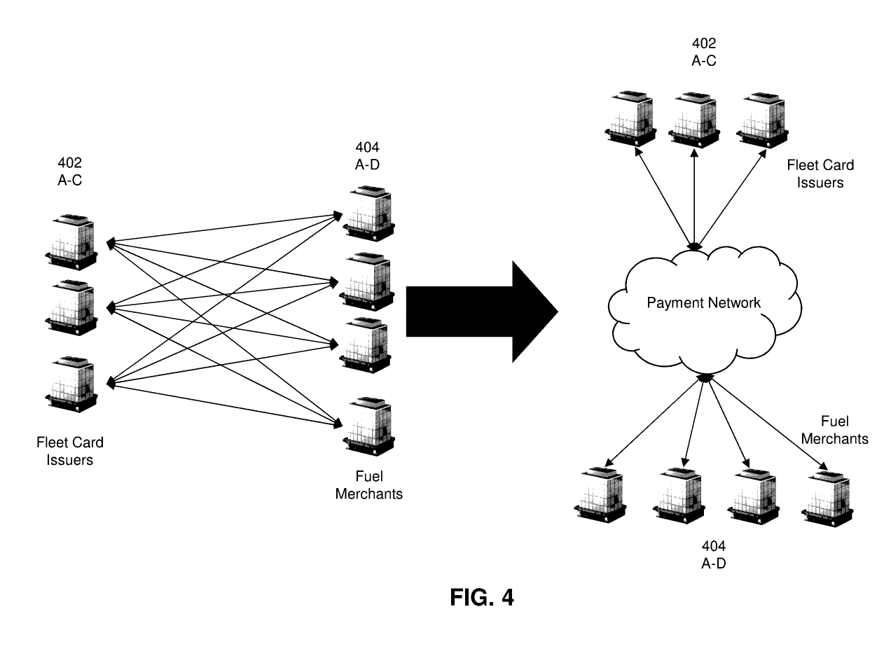

FIG. 4 illustrates a network topology of a traditional fleet card network and the next generation fleet network provided using the system 100 illustrated in FIG. 1 and discussed herein.

As illustrated on the left side of FIG. 4, a traditional fleet card network may include a plurality of fleet card issuers 402 and a plurality of fuel merchants 404. Each fleet card issuer 402 may build a relationship with each fuel merchant 404 to facilitate acceptance of their issued payment cards at the fuel merchant 404. Thus, every fleet card issuer 402 may have a separate relationship with each of the fuel merchants 404, and each fuel merchant 404 may have a relationship with every fleet card issuer 402. As a result, the topology of a traditional fleet card network can be very complicated, with a large number of relationships that constitute a lot of network infrastructure with each communication being subject to specialized configuration and programming and rules.

For instance, each fuel merchant 404 must be configured to communicate directly with each fleet card issuer 402 using protocols and standards set forth by the respective fleet card issuer 402, and must be configured to apply rules set forth by each fleet card issuer 402 for corresponding payment transactions. Therefore, each fleet card issuer 402 that a fuel merchant 404 wants to accept payment cards for requires the fuel merchant 404 to establish a new line of communication and specialized programming of their payment system to perform any necessary rules. As such, it may be difficult for fuel merchants 404 to cultivate a large number of relationships with fleet card issuers 402, which may in turn result in a smaller customer base and further result in less revenue.

The right side of FIG. 4 illustrates a next generation fleet card network accomplished using the methods and systems discussed herein. In the next generation fleet card network, the payment network 108 that includes the processing server 110 operates in between the fleet card issuers 402 and the fuel merchants 404 to simplify the network topology. Each of the fuel merchants 404 communicates directly to the payment network 110, without having to sustain separate lines of communication with each fleet card issuer 402. Similarly, each fleet card issuer 402 communicates directly with the payment network 110. As a result, the topology of the next generation fleet card network as discussed herein is greatly simplified over traditional networks, and can provide a great number of technical advantages.

For instance, fuel merchants 404 are no longer required to establish new lines of communication for each fleet card issuer 402, which may use varying communication protocols and data standards, and can therefore expand their customer base using a payment network 110 for which they are already configured without having to specially configure their systems for additional protocols and standards. In additional, fleet card issuers 402 may be able to process transactions with new fuel merchants 404 using whatever rules and communication protocols they are configured for, without building new lines of communication and requiring fuel merchants 404 to modify their existing systems in light of the fleet card issuer's rules. In addition, by applying the rules at the payment network 110, fleet card issuers 402 receive data that they require in the manner they prefer while fuel merchants 404 can provide transaction messages in a standardized fashion without special modifications being made that vary from transaction to transaction based on the fleet card issuer 402.

### Payment Card Transaction Processing

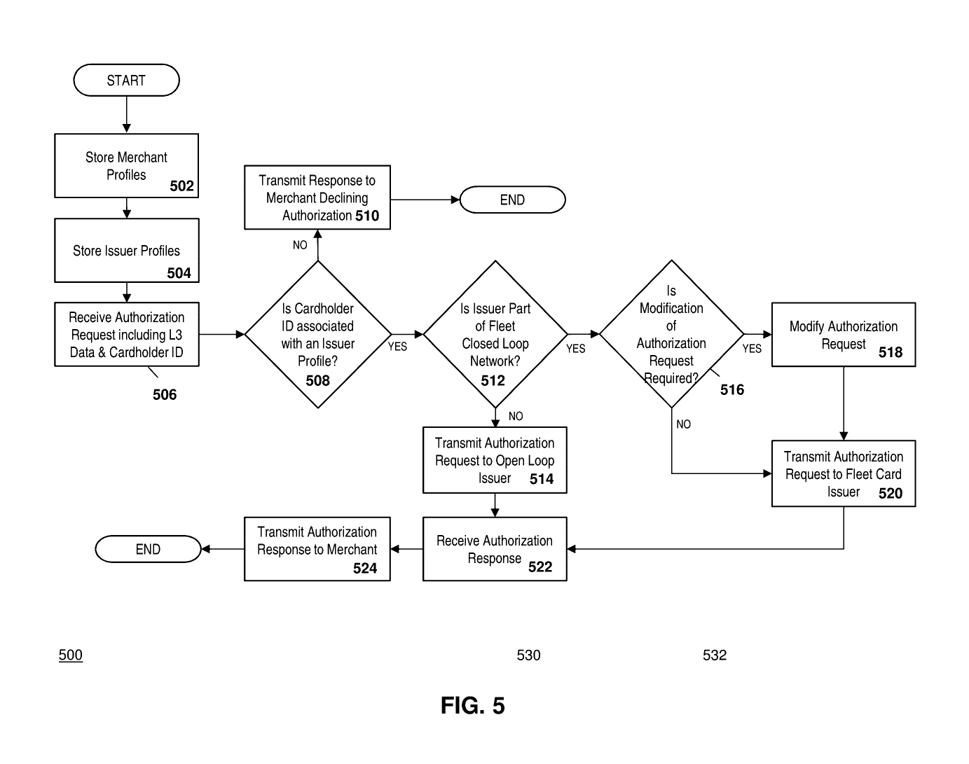

FIG. 5 illustrates a process 500 for the processing of payment card transactions at the processing server 110 including the processing of both fleet card transactions on closed loop networks and non-fleet on open loop networks.

In step 502, the processing server 110 may store merchant profiles 210 in the merchant file database 208. Each merchant profile 210 may include at least a merchant identifier and one or more loop type identifiers. In some instances, a merchant profile 210 may include one or more transaction rules. In step 504, the processing server 110 may store issuer profiles 214 in the fleet file database 212. Each issuer profile 214 may include at least an issuer identifier. In some instances, an issuer profile 214 may include one or more transaction rules, and/or one or more payment card identifiers.

In step 506, the receiving unit 202 of the processing server 110 may receive an authorization request for a payment transaction. The authorization request may be a transaction message formatted pursuant to one or more appropriate standards, such as the ISO 8583 standard, and may include a plurality of data elements, including at least a first data element that includes a payment card identifier associated with a payment card 104 used in the payment transaction. In some embodiments, the authorization request may further include level 3 data.

In step 508, the processing unit 204 of the processing server 110 may determine if the payment card identifier included in the authorization request is associated with an issuer profile 214. The determination may be based on attempt to identify an issuer profile 214 that includes a payment card identifier included in the authorization request. In some instances, the authorization request may include a merchant identifier. In such an instance, the determination may be further based on correspondence of the issuer identifier included in the identified issuer profile 214 with a loop type identifier in a merchant profile 210 stored in the merchant file database 208 (e.g., indicating merchant acceptance of that issuer's cards). If no such issuer profile 214 is identified, or if the merchant does not accept cards from the corresponding fleet card issuer 112, then, in step 510, the transmitting unit 206 of the processing server 110 may transmit an authorization response to the point of sale terminal 106 at the merchant declining the payment transaction.

If, in step 508, a valid issuer profile 214 is identified, then, in step 512, the processing unit 204 may determine if the related issuer is part of a fleet closed loop network. If the related issuer is not part of a fleet closed loop network, then, in step 514, the transmitting unit 206 of the processing server 110 may transmit the authorization request to the corresponding open loop network issuer 114. If, in step 512, the related issuer is determined to be part of a fleet closed loop network, then, in step 516, the processing unit 204 may further determine if modification of the authorization request is required. The determination may be based on data included in the identified issuer profile 214, such as the inclusion of one or more rules regarding modification of authorization requests.

If modification is indicated, then, in step 518, the processing unit 204 of the processing server 110 may modify the authorization request accordingly. Once modification is complete, or if no modification was necessary, then, in step 520, the transmitting unit 206 may transmit the authorization request to the fleet card issuer 112 related to the identified issuer profile 214.

Once the authorization request has been transmitted to the appropriate issuer, the receiving unit 202 of the processing server 110 may receive an authorization response, in step 522. The authorization response may be a transaction message that includes a message type indicator indicative of being an authorization response, and may include a data element configured to store a response code that indicates approval or denial of the payment transaction. In some instances, the authorization response may be a modification of the authorization request previously transmitted to the issuer. In step 524, the transmitting unit 206 of the processing server 110 may forward the received authorization response to the merchant point of sale terminal 106, for finalization of the payment transaction.

### Exemplary Method for Processing a Fleet Card Transaction

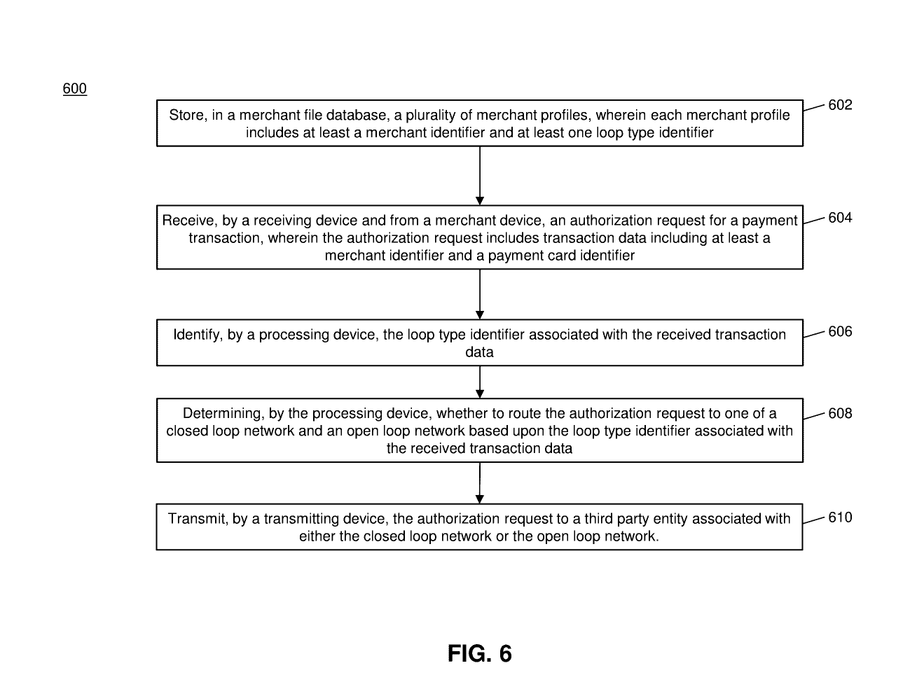

FIG. 6 illustrates a method 600 for processing a fleet card transaction using a next generation fleet network.

In step 602, a plurality of merchant profiles (e.g., merchant profiles 210) may be stored in a merchant file database (e.g., the merchant file database 208), wherein each merchant profile 210 includes at least a merchant identifier and at least one loop type identifier. In step 604, an authorization request for a payment transaction may be received from a merchant device (e.g., the point of sale terminal 106) by a receiving device (e.g., the receiving unit 202), wherein the authorization request includes transaction data including at least a merchant identifier and a payment card identifier. In one embodiment, the authorization request may include level 3 transaction data.

In step 606, the loop type identifier associated with the received transaction data may be identified by a processing device (e.g., the processing unit 204). In step 608, the processing device 204 may determine whether to route the authorization request to one of a closed loop network and an open loop network based upon the loop type identifier associated with the received transaction data.

In step 610, the authorization request may be transmitted by a transmitting device (e.g., the transmitting unit 206) to a third party entity associated with either the closed loop network or the open loop network. In one embodiment, the third party entity may be a fleet card issuer (e.g., fleet card issuer 112) associated with the closed loop network. In a further embodiment, the method 600 may also include: receiving, by the receiving device 202, an authorization request for a second payment transaction from a second merchant device 106, wherein the authorization request includes second transaction data including at least a second merchant identifier and the payment card identifier; identifying, by the processing device 204, the loop type identifier associated with the received second transaction data; determining, by the processing device 204, to route the authorization request to an open loop network based upon the loop type identifier associated with the received second transaction data; and transmitting, by the transmitting device, the authorization request to an issuer (e.g., an open loop network issuer 114) associated with the open loop network.

In some embodiments, the method 600 may further include: storing, in a fleet file database (e.g., the fleet file database 212), a plurality of fleet profiles (e.g., issuer profiles 214), wherein each fleet profile 214 includes at least an issuer identifier; identifying, by the processing device 204, a fleet profile 214 associated with the received payment card identifier; and determining, by the processing device 204, whether to update the authorization request based on the identified fleet profile 214. In a further embodiment, the method 600 may even further include updating, by the processing device 204, the authorization request to comply with criteria provided in the identified fleet profile 214.

In one embodiment, the method 600 may also include: determining, by the processing device 204, a transaction amount for the associated transaction; and updating, by the processing device 204, the authorization request to include the transaction amount. In some embodiments, the method 600 may further include: receiving, by the receiving device 202, an authorization response from the third party entity; and determining, by the processing device 204, whether to alter the authorization response. In a further embodiment, the processing device 204 may determine that the authorization response should be altered, and the method 600 may even further include: altering, by the processing device 204, the authorization response; and transmitting, by the transmitting device, the altered authorization response to the merchant.

### Computer System Architecture

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 5, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for processing fleet card transactions in a next generation fleet network. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a fleet card transaction, comprising:
storing, in a merchant file database, a plurality of merchant profiles, wherein each merchant profile includes at least a merchant identifier and at least one loop type identifier;
receiving, by a receiving device and from a merchant device, an authorization request for a payment transaction, wherein the authorization request includes transaction data including at least a merchant identifier and a payment card identifier;
identifying, by a processing device, the loop type identifier associated with the received transaction data;
determining, by the processing device, whether to route the authorization request to one of a closed loop network and an open loop network based upon the loop type identifier associated with the received transaction data; and
transmitting, by a transmitting device, the authorization request to a third party entity associated with either the closed loop network or the open loop network.

2. The method of claim 1, wherein the third party entity is a fleet card issuer associated with the closed loop network.

3. The method of claim 1, further comprising:
storing, in a fleet file database, a plurality of fleet profiles, wherein each fleet profile includes at least an issuer identifier;
identifying, by the processing device, a fleet profile associated with the received payment card identifier; and
determining, by the processing device, whether to update the authorization request based upon the identified fleet profile.

4. The method of claim 3, further comprising:
updating, by the processing device, the authorization request to comply with criteria provided in the identified fleet profile.

5. The method of claim 1, further comprising:
determining, by the processing device, a transaction amount for the associated transaction; and
updating, by the processing device, the authorization request to include the transaction amount.

6. The method of claim 1, further comprising:
receiving, by the receiving device and from the third party entity, an authorization response; and
determining, by the processing device, whether to alter the authorization response.

7. The method of claim 6, wherein the processing device determines that the authorization response should be altered, further comprising:
altering, by the processing device, the authorization response; and
transmitting, by the transmitting device and to the merchant, the altered authorization response.

8. The method of claim 1, wherein the authorization request includes Level 3 transaction data.

9. The method of claim 2, further comprising:
receiving, by the receiving device and from a second merchant device, an authorization request for a second payment transaction, wherein the authorization request includes second transaction data including at least a second merchant identifier and the payment card identifier;
identifying, by the processing device, the loop type identifier associated with the received second transaction data;
determining, by the processing device, to route the authorization request to an open loop network based upon the loop type identifier associated with the received second transaction data; and
transmitting, by the transmitting device, the authorization request to an issuer associated with the open loop network.

10. A system for processing a fleet card transaction, comprising:
a merchant file database configured to store a plurality of merchant profiles, wherein each merchant profile includes at least a merchant identifier and at least one loop type identifier;
a receiving device configured to receive, from a merchant device, an authorization request for a payment transaction, wherein the authorization request includes transaction data including at least a merchant identifier and a payment card identifier;
a processing device configured to:
identify the loop type identifier associated with the received transaction data, and
determine whether to route the authorization request to one of a closed loop network and an open loop network based upon the loop type identifier associated with the received merchant identifier; and
a transmitting device configured to transmit the authorization request to a third party entity associated with either the closed loop network or the open loop network.

11. The system of claim 10, wherein the third party entity is a fleet card issuer associated with the closed loop network.

12. The system of claim 10, further comprising:
a fleet file database configured to store a plurality of fleet profiles, wherein each fleet profile includes at least an issuer identifier; and
wherein the processing device is further configured to:
identify a fleet profile associated with the received payment card identifier, and
determine whether to update the authorization request based upon the identified fleet profile.

13. The system of claim 12, wherein the processing device is further configured to update the authorization request to comply with criteria provided in the identified fleet profile.

14. The system of claim 10, wherein the processing device is further configured to:
determine a transaction amount for the associated transaction, and
update the authorization request to include the transaction amount.

15. The system of claim 10, wherein the receiving device is further configured to receive, from the third party entity, an authorization response and wherein the processing device is further configured to determine whether to alter the authorization response.

16. The system of claim 15, wherein the processing device is further configured to alter the authorization response and the transmitting device is further configured to transmit the altered authorization response to the merchant.

17. The system of claim 10, wherein the authorization request includes Level 3 transaction data.

18. The system of claim 11, wherein,
the receiving device is further configured to receive, from a second merchant device, an authorization request for a second payment transaction, wherein the authorization request includes second transaction data including at least a second merchant identifier and the payment card identifier;
the processing device is further configured to:
identify the loop type identifier associated with the received second transaction data, and
determine whether to route the authorization request to the open loop network or the closed loop network based upon the loop type identifier associated with the received second transaction data; and
the transmitting device is further configured to transmit the authorization request to a third party entity associated with one of the open loop network or the closed loop network,
wherein the second transaction data is associated with the open loop network and the third party entity is an issuer associated with the open loop network.
